(19) United States
(12) Patent Application Publication
(10) Pub. No.: US 2020/0082798 A1
(43) Pub. Date: Mar. 12, 2020

(54) DRIVING METHODS AND DRIVING DEVICES FOR PIXEL UNITS OF IRREGULAR SHAPED DISPLAY SCREENS

(71) Applicant: Kunshan Go-Visionox Opto-Electronics Co., Ltd., Kunshan (CN)

(72) Inventor: Chunlei ZHANG, Kunshan (CN)

(21) Appl. No.: 16/680,515

(22) Filed: Nov. 12, 2019

Related U.S. Application Data
(63) Continuation of application No. PCT/CN2018/089649, filed on Jun. 1, 2018.

(30) Foreign Application Priority Data
Oct. 31, 2017 (CN) 201711048767.1

(51) Int. Cl. G09G 5/42; G09G 5/00

(52) U.S. Cl. CPC G09G 5/42; G09G 2310/0275; G09G 2320/0276; G09G 5/005

(57) ABSTRACT

A driving method and a driving device for a pixel unit of a display screen having an irregular shape, the driving method includes: receiving a driving signal for the pixel unit of the display screen having the irregular shape; determining whether the pixel unit driven by the driving signal is located in a position to be corrected with respect to the display screen having the irregular shape; when the pixel unit is located in the position to be corrected with respect to the display screen having the irregular shape, correcting the driving signal according to a preset manner; and driving the corresponding pixel unit using the corrected driving signal.

### CROSS-REFERENCES TO RELATED APPLICATIONS

This application is a continuation application of International Application No. PCT/CN2018/089649, filed on Jun. 1, 2018, entitled “DRIVING METHOD AND DRIVING DEVICE FOR PIXEL UNIT OF IRREGULAR SHAPED DISPLAY SCREEN”, which claims priority to Chinese Patent Application No. 201711048767.1, filed on Oct. 31, 2017, both of which are incorporated by reference herein for all purposes.

### TECHNICAL FIELD

The present disclosure relates to a field of display technology.

### BACKGROUND

With the development of electronic technology, electronic display screen is more and more diversified, and then the display screens with irregular shapes such as flat round cornered display screens and curved round cornered display screens are appeared.

In the conventional technology, typically, the pixel units are repeatedly arranged periodically in a stepped manner to meet the display requirements of the display screen having an irregular shape.

### SUMMARY

According to various embodiments of present disclosure, a driving method for a pixel unit of a display screen having an irregular shape is provided. The method includes: receiving a driving signal for the pixel unit of the display screen having the irregular shape; determining whether the pixel unit driven by the driving signal is located in a position to be corrected with respect to the display screen having the irregular shape; upon determining that the pixel unit is located in the position to be corrected with respect to the display screen having the irregular shape, correcting the driving signal according to a preset manner; and driving the corresponding pixel unit by using the corrected driving signal.

In one of the embodiments, the determining whether the pixel unit driven by the driving signal is located in the position to be corrected with respect to the display screen having the irregular shape includes: calculating a relative positional relationship between the pixel unit and a chamfered outline of the display screen having the irregular shape; determining whether the pixel unit is located in the position to be corrected according to the relative positional relationship.

In one of the embodiments, the calculating the relative positional relationship between the pixel unit and the chamfered outline of the display screen having the irregular shape includes: reading an address at which a driving unit of the pixel unit is configured; determining a set of addresses of the chamfered outline of the display screen having the irregular shape; and determining whether the pixel unit is located in a range defined by the chamfered outline, intersects the chamfered outline, or is located outside of the range defined by the chamfered line according to the address of the pixel unit and the set of addresses of the chamfered outline of the display screen having the irregular shape.

In one of the embodiments, the determining the set of addresses of the chamfered outline of the display screen having the irregular shape includes: determining the set of addresses of the chamfered outline of the display screen having the irregular shape by using Bresenham's circle algorithm.

In one of the embodiments, the determining whether the pixel unit driven by the driving signal is located in the position to be corrected with respect to the display screen having the irregular shape includes: determining the pixel unit is located in the position to be corrected when the pixel unit intersects the chamfered outline or is located outside of the range defined by the chamfered line.

In one of the embodiments, the correcting the driving signal according to the preset manner includes: correcting the pixel unit according to a first manner or a second manner when the pixel unit intersects the chamfered outline; and correcting the pixel unit according to the first manner or the second manner when the pixel unit is located outside of the range defined by the chamfered line.

In one of the embodiments, the first manner is to correct a gamma value of the driving signal, and the second manner is to correct a data voltage of the driving signal.

In one of the embodiments, the gamma value of the corrected driving signal is greater than 2.2.

In one of the embodiments, the data voltage of the corrected driving signal ranges from 5V to 6V.

The present disclosure also provides a driving device for a pixel unit of a display screen having an irregular shape. The device includes a memory, a processor, and a computer program stored in the memory and capable of running on the processor, and the processor can implement the driving method for the pixel unit of display screen having the irregular shape according to any one of aforementioned embodiments when executing the computer program.

In one of the embodiments, the memory can be permanent medium, non-permanent medium, removable medium, or non-removable medium.

In one of the embodiments, the processor can be a processor (CPU), a graphics processing unit (GPU), a microprocessor (MCU) or a single chip, or a processing chip.

The driving method and driving device for the pixel unit of the display screen having the irregular shape have the following advantageous effects:

When the pixel unit of the display screen is located at the position to be corrected, after the driving signal of the pixel unit is corrected and the corresponding pixel unit is driven, the brightness of the pixel unit can be reduced, thereby reducing the jaggedness or graininess of the chamfered area.

### BRIEF DESCRIPTION OF THE DRAWINGS

FIG. 1 is a flowchart of a driving method for a pixel unit of a display screen having an irregular shape according to an embodiment of the present disclosure.

FIG. 2 is a schematic view of a circuit of a pixel unit according to an embodiment of the present disclosure.

### DETAILED DESCRIPTION OF THE INVENTION

Applicants found various deficiencies in conventional displays. For example, when arranged in the stepped manner to meet the display requirements of the display screen having an irregular shape, since the periodic arrangement in the stepped manner of rectangular sub-pixels cannot fill the display screen completely, the chamfered area of the display screen shows a jaggedness and affects the display effect.

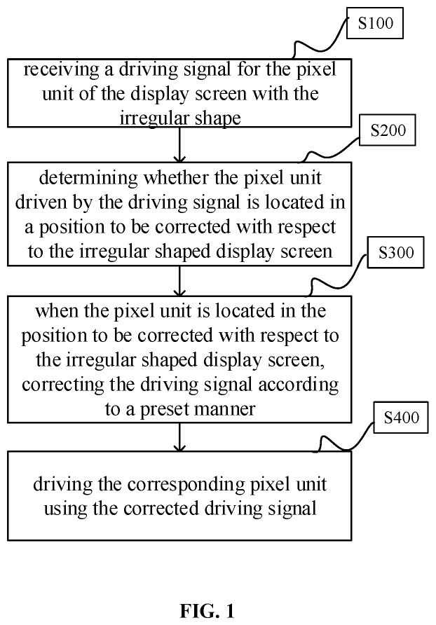

Referring to FIG. 1, the present disclosure provides a driving method for a pixel unit of a display screen having an irregular shape, includes:

Step S100: a driving signal for the pixel unit of the display screen having the irregular shape is received.

The display screen having the irregular shape is a special shaped display screen developed on the basis of the conventional display screen. The display screen having the irregular shape has shape different from the rectangular or planar shapes of conventional display screens. The spatial structure of the display screen having the irregular shape is generally a portion taken from a sphere, or a portion taken from a cylinder, or a portion taken from a rectangular parallelepiped. The display surface of the display screen having the irregular shape is a three-dimensional curved surface corresponding to the sphere or the cylinder, or at least a two-dimensional plane having a curved outline. The edge outline of the display surface of the corresponding display screen having the irregular shape is a space curve or a plane curve.

A pixel unit (PX) is generally referred to simply as a pixel. Each pixel unit may have respective color values, and may be displayed in three primary colors. Therefore, the pixel unit may be composed of a green sub-pixel, a blue sub-pixel, and a red sub-pixel.

The number of different colors expressed by a pixel unit depends on the bit per pixel (BPP). This number of colors can be obtained by taking the color depth power of 2. For example, common values are:

8 bpp: 256 colors, also known as “8-bit”;

16 bpp: 65,536 colors, called high color, also known as “16-bit”;

24 bpp: 16,777,216 colors, called true color, the usual notation is “16.7 million colors, and also known as “24-bit”; and

32 bpp: 224+28, the 32-bit color that is common in the computer field does not represent 232 colors, but means that the gray scale of 8 bits (28=256 levels) are increased on the basis of the 24-bit color. Therefore, the total number of colors of 32-bit and 24-bit are the same, and the 32-bit is also called full color.

In the computer field, each of the pixels is presents by 24 bits, and each of the three primary colors (red, green, and blue) has 8 bits. The intensity of each primary color is divided into 256 values according to the highest value 28 of the 8 bits.

The driving signal of the pixel unit includes electrical parameter values such as color depth, color level, and data voltage. When the display screen having the irregular shape displays a picture, a video decoding chip decodes the data corresponding to the picture and then sends the data to a driving chip. The driving chip drives the pixel unit according to the obtained data to perform display.

Step S200: whether the pixel unit driven by the driving signal is located in a position to be corrected with respect to the display screen having the irregular shape is determined.

When the display screen has a chamfer, the chamfer outline on the edge of the chamfer is a smooth curve, and the pixel unit or the sub-pixel is an entity having a certain size. When the pixel unit is distributed along the chamfered contour in a manner of fitting the chamfered contour, the jaggedness or graininess inevitably occur.

In the present disclosure, whether the pixel unit driven by the driving signal is located in the position to be corrected with respect to the display screen having the irregular shape is determined, therefore when the pixel unit is located in the position to be corrected, the driving signal of the pixel unit is corrected in a subsequent process, thereby reducing the jaggedness and graininess.

Additionally, in one of the embodiments, the determining whether the pixel unit driven by the driving signal is located in the position to be corrected with respect to the display screen having the irregular shape specifically includes: calculating a relative positional relationship between the pixel unit and a chamfered outline of the display screen having the irregular shape; determining whether the pixel unit is located in the position to be corrected according to the relative positional relationship.

The pixel unit can be driven by the driving chip. The address of the pixel unit can be configured in the execution program of the driving chip, such that the pixel unit is independently driven. Whereas for the customized display screen having the irregular shape, the size of the chamfer set by the display screen having the irregular shape has generally been determined. Then, a set of addresses of the chamfered outline can be configured in the execution program of the driving chip. Thus, it can be determined whether the pixel unit is in the position to be corrected according to the address of the pixel unit and the set of addresses of the chamfered outline.

Additionally, in one of the embodiments, the calculating the relative positional relationship between the pixel unit and the chamfered outline of the display screen having the irregular shape specifically includes: reading the address at which a driving unit of the pixel unit is configured; determining the set of addresses of the chamfered outline of the display screen having the irregular shape; and determining whether the pixel unit is located in an active display range defined by the chamfered outline, or intersects the chamfered outline, or is located outside of the range defined by the chamfered line according to the address of the pixel unit and the set of addresses of the chamfered outline of the display screen having the irregular shape.

Specifically, for example, when the address of the pixel unit is less than the lower limit value in the set of addresses, it can be determined that the pixel unit is located within the range defined by the chamfered contour. When the address of the pixel unit is equal to the set of addresses of the chamfered outline, it can be determined that the pixel unit intersects the chamfered outline. When the address of the pixel unit is greater than the upper limit of the set of addresses, it can be determined that the pixel unit is located outside of the range defined by the chamfered line.

Additionally, in one of the embodiments, the determining the set of addresses of the chamfered outline of the display screen having the irregular shape specifically includes: determining the set of addresses of the chamfered outline of the display screen having the irregular shape by using Bresenham's circle algorithm.

Bresenham's circle algorithm uses a series of discrete points to approximate a circle. Therefore, the set of addresses of the chamfered outline is a set of coordinates. The Bresenham algorithm is described in detail in computer graphics and will not be described here.

Additionally, in one of the embodiments, the determining whether the pixel unit is in the position to be corrected specifically includes: determining the pixel unit is located in the position to be corrected when the pixel unit intersects the chamfered outline or is located outside of the range defined by the chamfered line.

In the embodiment according to the present disclosure, either the pixel units intersecting the chamfer outline or the pixel units located outside of the range defined by the chamfered line can be corrected, or the pixel units intersecting the chamfer outline and the pixel units located outside of the range defined by the chamfered line can be corrected simultaneously.

Step S300: when the pixel unit is determined that it is located in the position to be corrected with respect to the display screen having the irregular shape, the driving signal is corrected according to a preset manner.

Additionally, in one of the embodiments, the correcting the driving signal according to the preset manner specifically includes: correcting the pixel unit according to a first manner or a second manner when the pixel unit intersects the chamfered outline; and correcting the pixel unit according to the first manner or the second manner when the pixel unit is located outside of the range defined by the chamfered line.

In the illustrated embodiment, the pixel units intersecting the chamfer outline can be corrected according to the first manner, and the pixel units located outside of the range defined by the chamfered line can be corrected according to the first manner. Or the pixel units intersecting the chamfer outline can be corrected according to the first manner, and the pixel units located outside of the range defined by the chamfered line can be corrected according to the second manner. The pixel units intersecting the chamfer outline can also be corrected according to the second manner, and the pixel units located outside of the range defined by the chamfered line can also be corrected according to the first manner. Moreover, the pixel units intersecting the chamfer outline can also be corrected according to the second manner, and the pixel units located outside of the range defined by the chamfered line can also be corrected according to the second manner.

Additionally, in one of the embodiments, the first manner is to correct a gamma value of the driving signal, and the second manner is to correct a data voltage of the driving signal.

A complete image system requires two gamma values to interpret, encoding gamma and display gamma. The encoding gamma describes the relationship between the scene radiance value captured by an image device and the encoded pixel value, expressed by the formula x=F^{encoding gamma}, where F represents the scene brightness value, X represents the encoded pixel value. The relationship between the brightness value displayed on the display screen and the encoded pixel value is represented by the formula Y=X^{display gamma}, where Y is the brightness value displayed on the display screen, and X is the encoded pixel value. Then, the final relationship between the brightness value displayed by the display screen and the brightness value of the scene captured by the image device is Y=X^{display gamma}=(F^{encoding gamma})^{display gamma}. When the encoded gamma and the display gamma are reciprocal to each other, the display screen can realistically reproduce the scene. Therefore, for the image data that has been acquired, the pixel value is determined, and the brightness of the display screen can be changed by correcting the display gamma. That is to say, the brightness of the displayed image can be changed by adjusting the display gamma.

Additionally, in one of the embodiments, the gamma value of the corrected driving signal is greater than 2.2.

Generally, the larger the gamma value of the display screen is set, the darker the image is. In the illustrated embodiment, when it is recognized that the pixel unit is located in the position to be corrected, a preset gamma value is input, such that the brightness of the pixel unit in the position to be corrected is lowered to reduce the jaggedness or graininess.

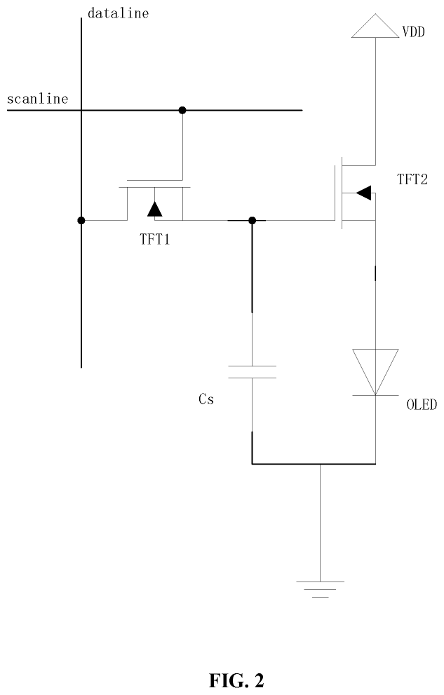

As shown in the driving circuit of a pixel unit in FIG. 2, the brightness of the pixel unit can be changed by changing the data voltage of the dataline.

Additionally, in one of the embodiments, the data voltage of the corrected driving signal approaches the cut-off voltage of the driving transistor TFT2, generally, the data voltage of the corrected driving signal is selected from 5V to 6V.

Generally, VDD can be set to around 4.6V. When the data voltage of the driving signal is set to approach the cut-off voltage of the driving transistor TFT2, the driving transistor TFT2 approaches to be turned off, such that the rightness of the pixel unit is significantly reduced. Therefore, the jaggedness or graininess can be reduced.

Step S400: the corresponding pixel unit is driven by using the corrected driving signal.

After the driving signal of the pixel unit is corrected and the corresponding pixel unit is driven, the brightness of the pixel unit can be reduced, thereby reducing the jaggedness or graininess.

The above is the driving method for the pixel unit of the display screen having the irregular shape according to the present disclosure. By configuring the driving chip, the brightness of the pixel unit in the position to be corrected can be reduced, thereby reducing the jaggedness or graininess.

The present disclosure also provides a driving device for a pixel unit of a display screen having an irregular shape. The device includes a memory, a processor, and a computer program stored in the memory and capable of running on the processor, and the processor can implement any one of aforementioned the driving methods when executing the computer program.

The memory herein includes both permanent and non-permanent, removable and non-removable media, and information storage can be implemented by any method or technique. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disk read only memory (CD-ROM), digital versatile disk (DVD) or other optical storage, magnetic cassette, tape storage or other magnetic storage device or any other non-transportable medium can be used to store information that can be accessed by a computer device.

The processor here may be a processor (CPU), a graphics processing unit (GPU), a microprocessor (MCU) or a single chip, a processing chip, and a computing cluster, a server, a PC, laptops, tablets, mobile phones and other devices including the above processor or the processor chip.

Although the present disclosure is illustrated and described herein with reference to specific embodiments, the present disclosure is not intended to be limited to the details shown. It is to be noted that, various modifications may be made in the details within the scope and range of equivalents of the claims and without departing from the present disclosure. Therefore, the protection scope of the present disclosure shall be subject to the protection scope of the claims.

1. A driving method for a pixel unit of a display screen having an irregular shape, the method comprising:
receiving a driving signal for the pixel unit of the display screen having the irregular shape;
determining whether the pixel unit driven by the driving signal is located in a position to be corrected with respect to the display screen;
upon determining that the pixel unit is located in the position to be corrected with respect to the display screen, correcting the driving signal according to a preset manner; and
driving the corresponding pixel unit by using the corrected driving signal.

2. The driving method according to claim 1, wherein the determining whether the pixel unit driven by the driving signal is in the position to be corrected with respect to the display screen comprises:
calculating a relative positional relationship between the pixel unit and a chamfered outline of the display screen; and
determining whether the pixel unit is located in the position to be corrected according to the relative positional relationship.

3. The driving method according to claim 2, wherein the calculating the relative positional relationship between the pixel unit and the chamfered outline of the display screen having the irregular shape comprises:
reading an address at which a driving unit of the pixel unit is configured;
determining a set of addresses of the chamfered outline of the display screen having the irregular shape; and
determining whether the pixel unit is located in a range defined by the chamfered outline, or intersects the chamfered outline, or is located outside of the range defined by the chamfered line according to the address of the pixel unit and the set of addresses of the chamfered outline of the display screen having the irregular shape.

4. The driving method according to claim 3, wherein the determining the set of addresses of the chamfered outline of the display screen having the irregular shape comprises:
determining the set of addresses of the chamfered outline of the display screen having the irregular shape by using a Bresenham's circle algorithm.

5. The driving method according to claim 2, wherein the determining whether the pixel unit is located in the position to be corrected comprises:
determining the pixel unit is located in the position to be corrected when the pixel unit intersects the chamfered outline or is located outside of the range defined by the chamfered line.

6. The driving method according to claim 1, wherein the correcting the driving signal according to the preset manner comprises:
correcting the pixel unit according to a first manner or a second manner when the pixel unit intersects the chamfered outline; and
correcting the pixel unit according to the first manner or the second manner when the pixel unit is located outside of the range defined by the chamfered line.

7. The driving method according to claim 6, wherein the first manner is to correct a gamma value of the driving signal, and the second manner is to correct a data voltage of the driving signal.

8. The driving method according to claim 7, wherein the gamma value of the corrected driving signal is greater than 2.2.

9. The driving method according to claim 8, wherein the data voltage of the corrected driving signal ranges from 5V to 6V.

10. A driving device for a pixel unit of a display screen having an irregular shape, comprising:
a memory;
a processor; and
a computer program stored in the memory and capable of running on the processor, the processor being capable of implementing the driving method for the pixel unit of display screen having the irregular shape according to claim 1 when executing the computer program.

11. The driving device according to claim 10, wherein the determining whether the pixel unit driven by the driving signal is in the position to be corrected with respect to the display screen comprises:
calculating a relative positional relationship between the pixel unit and a chamfered outline of the display screen having the irregular shape;
determining whether the pixel unit is located in the position to be corrected according to the relative positional relationship.

12. The driving device according to claim 11, the calculating the relative positional relationship between the pixel unit and the chamfered outline of the display screen comprises:
reading an address at which a driving unit of the pixel unit is configured;
determining a set of addresses of the chamfered outline of the display screen; and
determining whether the pixel unit is located in a range defined by the chamfered outline, or intersects the chamfered outline, or is located outside of the range defined by the chamfered line according to the address of the pixel unit and the set of addresses of the chamfered outline of the display screen having the irregular shape.

13. The driving device according to claim 12, wherein the determining the set of addresses of the chamfered outline of the display screen having the irregular shape comprises:
determining the set of addresses of the chamfered outline of the display screen having the irregular shape by using Bresenham's circle algorithm.

14. The driving device according to claim 11, wherein the determining whether the pixel unit is located in the position to be corrected comprises:
determining the pixel unit is located in the position to be corrected when the pixel unit intersects the chamfered outline or is located outside of the range defined by the chamfered line.

15. The driving device according to claim 10, wherein the correcting the driving signal according to the preset manner comprises:
correcting the pixel unit according to a first manner or a second manner when the pixel unit intersects the chamfered outline; and
correcting the pixel unit according to the first manner or the second manner when the pixel unit is located outside of the range defined by the chamfered line.

16. The driving device according to claim 15, wherein the first manner is to correct a gamma value of the driving signal, and the second manner is to correct a data voltage of the driving signal.

17. The driving device according to claim 16, wherein the gamma value of the corrected driving signal is greater than 2.2.

18. The driving device according to claim 17, wherein the data voltage of the corrected driving signal ranges from 5V to 6V.

19. The driving device according to claim 10, wherein the memory is selected from any one of permanent medium, non-permanent medium, removable medium, and non-removable medium.

20. The driving device according to claim 10, wherein the processor is selected from any one of a central processing unit, a graphics processing unit, a microprocessor or a single chip, and a processing chip.
